(19) United States
(12) Patent Application Publication
(10) Pub. No.: US 2019/0178457 A1
(43) Pub. Date: Jun. 13, 2019

(54) NOVELTY DEVICE

(71) Applicant: Curtis Michael Keller, Cleveland, OH (US)

(72) Inventor: Curtis Michael Keller, Cleveland, OH (US)

(21) Appl. No.: 16/216,498

(22) Filed: Dec. 11, 2018

Related U.S. Application Data
(60) Provisional application No. 62/597,161, filed on Dec. 11, 2017.

(51) Int. Cl. F21S 10/00; F21V 9/12

(52) U.S. Cl. CPC F21S 10/002; F21W 2131/30; F21V 9/12

(57) ABSTRACT

A novelty device comprising a vessel that includes a composition comprising water, oil, and particles (e.g., sand) that do not dissolve in either oil or water. When the contents of the novelty device are mixed (e.g., by manual manipulation or mechanical mixing) the water, oil, and particles form a column(s) of rising and descending material that forms various patterns. Various patterns may be produced depending on how the vessel and/or contents of the vessel are manipulated.

### CROSS-REFERENCE TO RELATED APPLICATIONS

This application claims the benefit of U.S. Provisional Patent Application Ser. No. 62/597,161 entitled “Novelty Device” filed on Dec. 11, 2017 which is is incorporated by reference in its entirety herein.

### BACKGROUND

Novelty devices such as lava lamps provide enjoyment for many users. The various moving patterns are pleasing to watch and provide interesting decorative features. Lava lamps, however, often include toxic materials that must be heated in order to create moving effects. These devices, while enjoyable, do not provide any level of interactivity on the part of the user and the user has no control over the patterns formed by the contents within the lava lamp. Thus, there remains a need for an interactive novelty device that includes non-toxic contents.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

According to an aspect, the innovation provides a novelty device comprising a vessel that includes a composition comprising water, oil, and particles (e.g., sand) that do not dissolve in either oil or water. When the contents of the novelty device are mixed (e.g., by manual manipulation or mechanical mixing) the water, oil, and particles form a column(s) of rising and descending material that forms various patterns. Various patterns may be produced depending on how the vessel and/or contents of the vessel are manipulated. For example, in some embodiment, the vessel may be inverted multiple times to form a given pattern. In another embodiment, the vessel by be swirled after being inverted to form a different pattern. In one embodiment, the device is a novelty lamp that may include a composition that forms different patterns/effects in use. In one embodiment, the composition inside the novelty lamp may include water, oil, and particles that do not dissolve in either water or oil. According to an aspect of the innovation, all of the components of the composition are non-toxic.

According to an aspect, the novelty device may be used to create and enjoy various moving patterns to entertain and/or soothe an observer. In one embodiment, the novelty device may be used to create different patterns or rising and descending material for viewing. The novelty device may also be interactive, allowing the user to manipulate the pattern of rising and descending material by employing different techniques for mixing the contents within the device.

In one embodiment, the novelty device (e.g., a lamp) may comprise a water-tight vessel having a cap. Inside the vessel is a composition that may include water, oil, and particles that do not dissolve in either the water or the oil. When the contents of the vessel are mixed, the oil coats the particles to form a globule(s) of material that, depending on how the contents are mixed (e.g., the motion used for mixing, the amount of mixing, or the force applied for mixing) creates various patterns of rising and descending material. The rising and descending material will continue to form patterns without additional manipulation for a least a period of time. The period of time will depend on the type and duration of the mixing manipulation. Any of the contents of the vessel may include color. For example, the water or the oil may include a dye or the particles may be colored particles.

In one embodiment, the contents within the vessel are non-toxic. In one embodiment, the water may be most any type of suitable water. Suitable waters include tap water, distilled water, purified water, sterilized water, or spring water.

In one embodiment, the oil is any suitable oil of proper viscosity. It is to be appreciated that the viscosity of the oil may be selected to facilitate selection of various designs/themes. Suitable non-toxic oils include canola oil, corn oil, soybean oil, peanut oil, sunflower oil, safflower oil, cottonseed oil, coconut oil, olive oil, palm oil or a combination of two or more thereof.

The particles included in the contents within the vessel can be most any particle so long as it does not dissolve in either oil or water. Suitable particles include sand, such as play sand. In one embodiment, at least a portion of the particles are luminescent. The particles may include various sizes of particles and particles having different densities. Particles may include glitter particles, rocks, and other decorative elements. Decorative elements may include shapes such as planetary shapes, animal shapes, plant shapes, food shapes, or any other decorative shape.

In one embodiment, the novelty device may include a base in which the vessel may sit. In one embodiment, either the base, the cap, or both, may include a light for illuminating the vessel and/or the contents of the vessel. The base may also include a mixing device to assist in mixing the contents of the vessel. This mixing device is operatively connected to the vessel such that operation of the mixing device causes mixing of the contents of the vessels. The mixing device may be controlled by the user so as to create desired effects.

In one embodiment, the mixing device may be a pump, a compressed air dispenser, a conveyor, an impeller, or a combination of two or more thereof.

In one embodiment, the water-tight vessel may be most any type of vessel including, but not limited to, a glass or plastic vessel. In one embodiment, the vessel includes a non-stick coating to prevent the contents of vessel from sticking to the inner wall of the vessel. In one embodiment, the vessel is a glass bottle including a non-stick coating on the inside of the vessel to prevent the contents of the vessel from sticking to the inner wall of the vessel. In one embodiment, the vessel may be encased in a protective coating or shell.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 is a drawing of an embodiment of the novelty device according to an embodiment of the innovation.

FIG. 2 is a drawing of an embodiment of the novelty device according to an embodiment of the innovation.

FIG. 3 is a drawing of an embodiment of the novelty device according to an embodiment of the innovation.

FIG. 4 is a drawing of an embodiment of the novelty device according to an embodiment of the innovation.

FIG. 5 is a drawing of an embodiment of the novelty device according to an embodiment of the innovation.

FIG. 6 is a drawing of an embodiment of the novelty device according to an embodiment of the innovation.

FIG. 7 is a drawing of an embodiment of the novelty device according to an embodiment of the innovation being used to create a pattern of ascending and descending material.

FIG. 8 is a drawing of an embodiment of the novelty device according to an embodiment of the innovation having a protective case.

FIG. 9 is a drawing of an embodiment of the novelty device according to an embodiment of the innovation having a mechanical mixer.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

According to an aspect, the innovation provides a novelty device comprising a vessel that includes a composition comprising water, oil, and particles (e.g., sand) that do not dissolve in either oil or water. In one embodiment, the device is a novelty lamp that may include a composition that forms different patterns/effects in use. In one embodiment, the composition inside the novelty lamp may include water, oil, and particles that do not dissolve in either water or oil. In one embodiment, all of the components of the composition are non-toxic.

In one embodiment, the device is a fluid dynamics training aid.

In one embodiment, the water may be most any form of water available to one of skill in the art. Suitable types of water include tap water, distilled water, purified water, sterilized water, spring water, and the like.

In one embodiment of the innovation, the oil may be most any type of oil available to one of skill in the art. In one embodiment, the oil is a vegetable oil. Examples of suitable vegetable oils include canola oil, corn oil, soybean oil, peanut oil, sunflower oil, safflower oil, cottonseed oil, coconut oil, olive oil, palm oil or a combination of two or more thereof. In one embodiment, the oil is a mineral oil. In one embodiment, the oil may be any oil that is appropriately viscous. In one embodiment, the oil is canola oil.

The viscosity of the oil affects not only the speed at which it moves but also the rate/ratio at which it releases and retains other materials. Testing, as described herein has demonstrated that canola oil and its viscosity have been proven reliable in producing consistent results. It should be appreciated that, depending on the desired effect, one of skill in the art may select an oil having suitable properties.

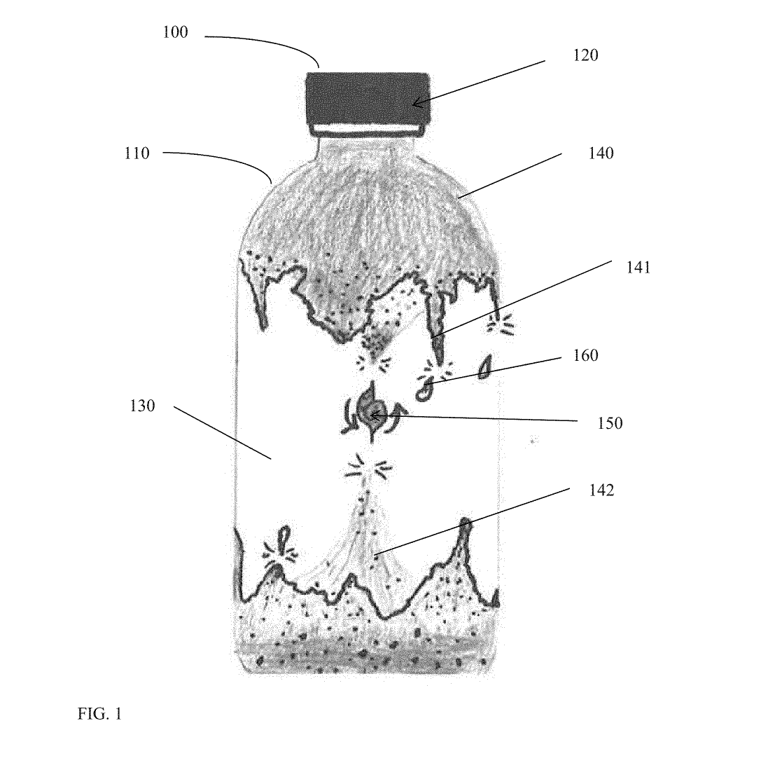

Turning now to FIG. 1, an embodiment of the innovation is provided. FIG. 1 depicts a novelty device 100. The novelty device includes a water-tight vessel 110 having a cap 120. Inside, the vessel 110, contains water 130 and a mixture of oil and sand. The oil and sand when mixed 150 form a globule 140. After mixing 150, this globule can create different patterns of moving oil coated particles. In this embodiment, the globule has descending portions 141 and ascending portions 142 of particles. Smaller globules 160 may also form that are independent from the main globule 140.

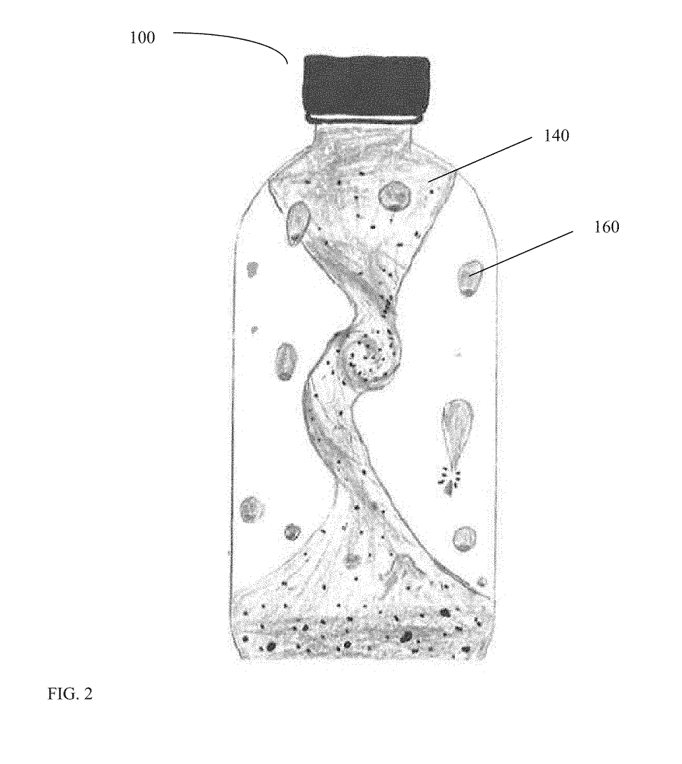

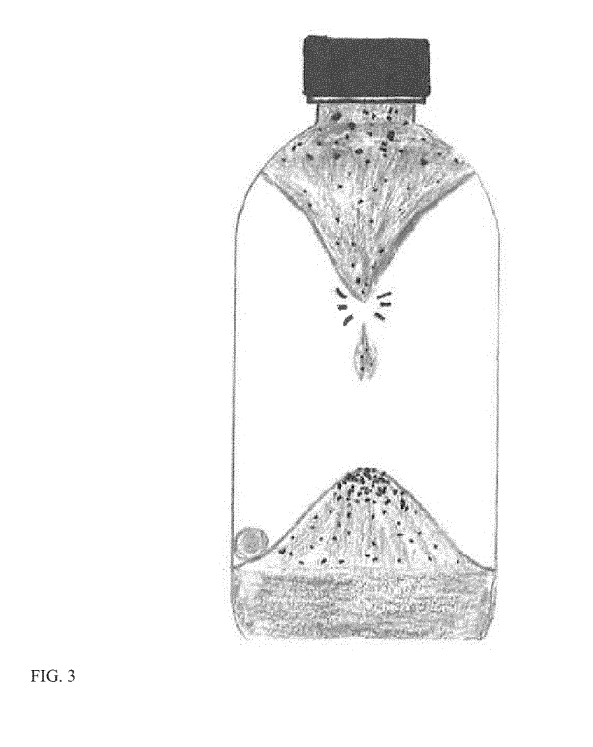

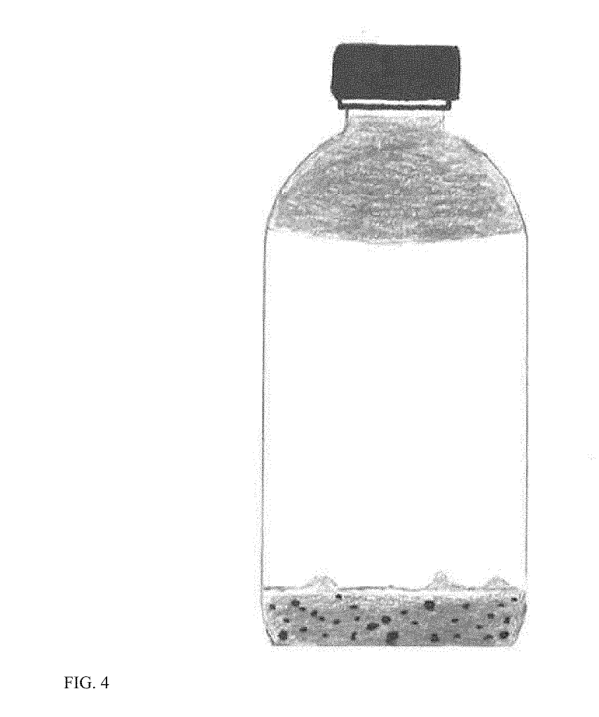

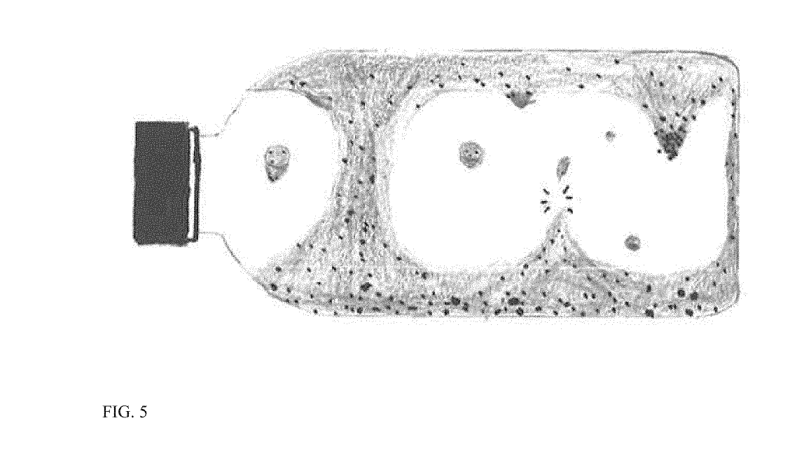

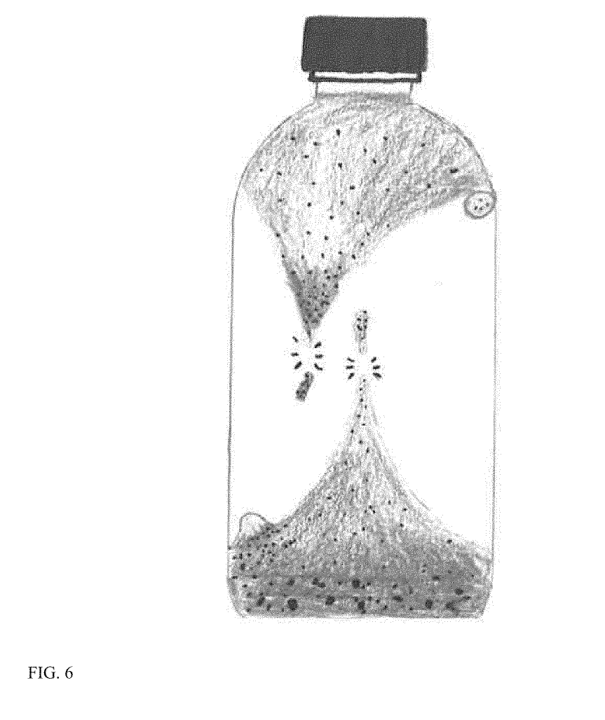

FIG. 2 depicts the novelty device 100 in which the contents of the vessel form a different patter. The main globule 140 forms a moving column of particles. Smaller globules 160 also form and create their own pattern. As described herein, the patterns produced can be controlled by the type, duration, and/or vigorousness of the mixing. As can be appreciated, many different patterns may be formed using the novelty device of the present innovation. FIGS. 3-6 depict additional possible patterns formed using an embodiment of the innovation.

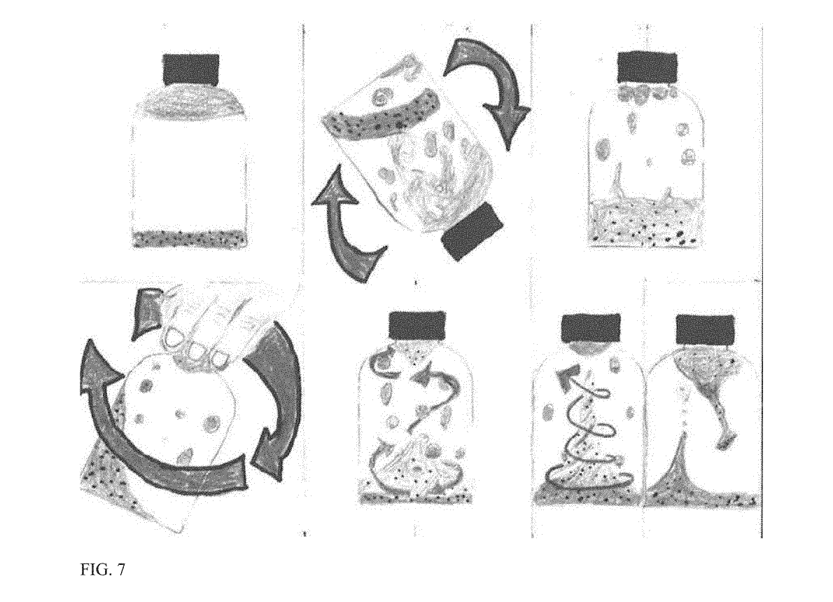

FIG. 7 depicts an embodiment of the innovation being used to create a pattern of ascending and descending material based on how the contents of the vessel are mixed.

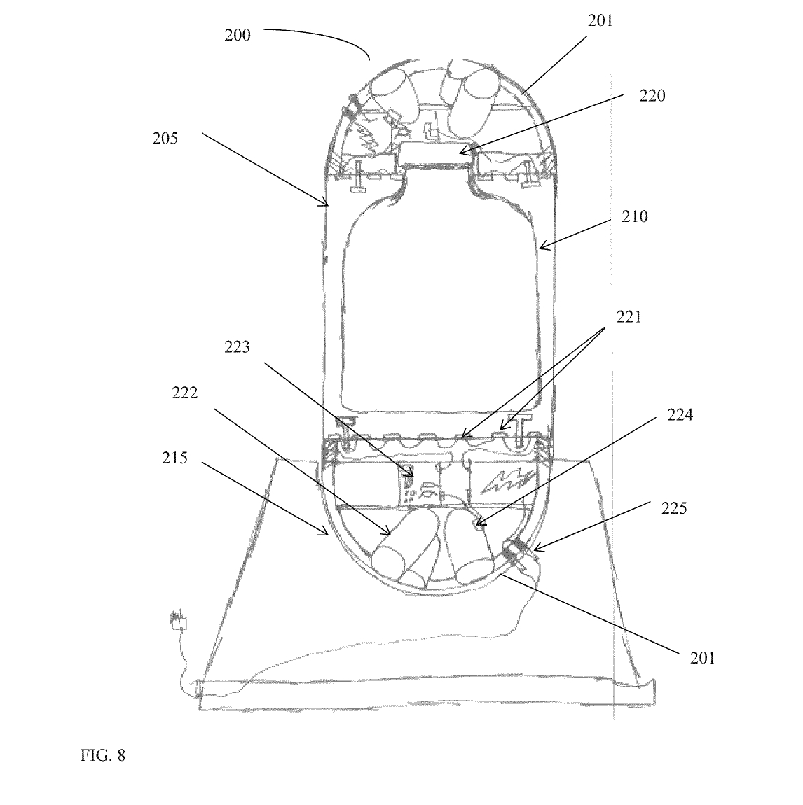

FIG. 8 depicts an embodiment of the novelty device 200 wherein the vessel 210 is encased in a protective shell 205. The novelty device includes a base 215 and may include a power source 225. The novelty device 200 may have end caps 201 that house various features. In one embodiment, the end caps may include grips 222 for holding the vessel and for mixing the contents of the vessel. The novelty device 200 may also include lighting features such as LEDs 221 being controlled by a circuit board 223. In the embodiment depicted in FIG. 8, a button or switch 224 may be located within one of the grips 222. It is to be understood that this button or switch can be located anywhere on the device so long as a user can activate it. In one embodiment, either or both of the caps may include such features.

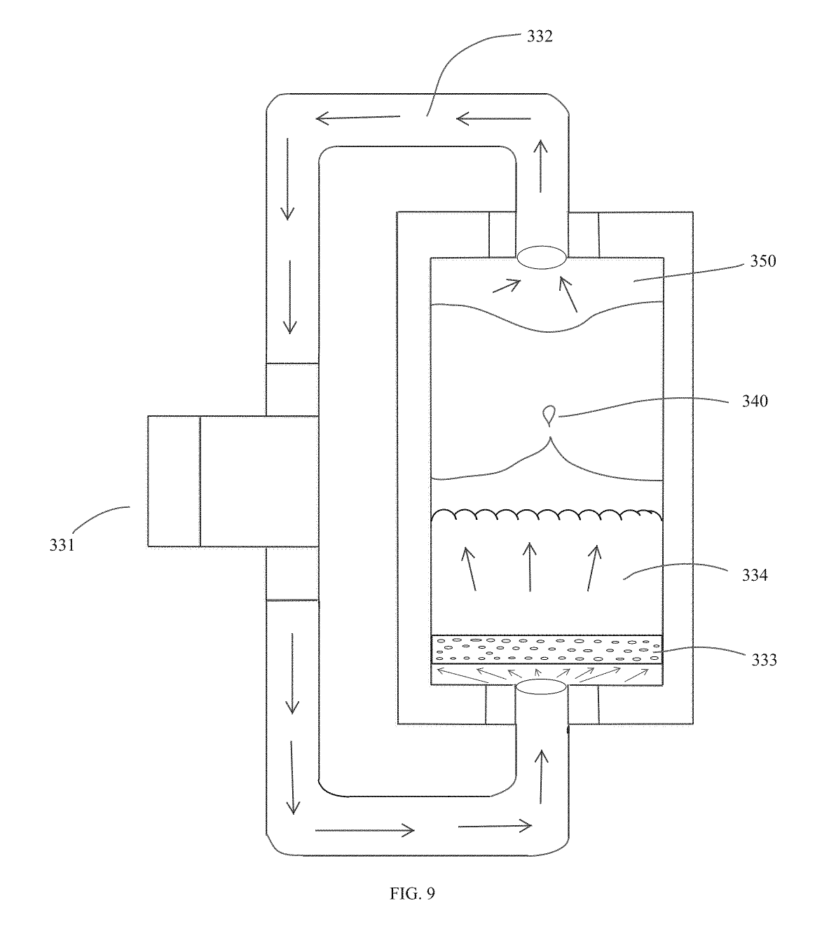

Turning now to FIG. 9, a depiction of mechanical mixing of the contents of a vessel is provided. FIG. 9 depicts a schematic showing the mixing of the contents of a vessel via a mechanical device (e.g., a pump 331). The pump includes connecting tubing 332 (e.g., hoses) for circulation of the contents within the vessel. In one embodiment, the oil may be circulated to mix the contents of a vessel. Circulation of the oil through the vessel may follow any path. In this embodiment, the oil circulates clockwise as shown by the arrows. A filter 333 may be under the sand 334 through which the circulating oil may flow. Mixture of the oil and the sand forms a sand/oil mix 350 and globules 340 as described herein.

According to an aspect of the innovation, the composition inside the device (e.g., the novelty lamp) may include particles that are suspended in the oil/water. In one embodiment, the particles comprise sand (e.g., play sand available from Estes, Sandtastik, and Sand Art). The particles may also include other types of particles such as silica, quartz, etc. The particles can be of most any size and varying sizes of particles may be included in the device to create different effects in use. In one embodiment, the particles have a granule size of 300 mesh and below.

In one embodiment, the particles may further comprise glow in the dark particles (e.g., glow in the dark sand). The glow in the dark sand particles may have substantially the same granule size as the particles. In one embodiment, the glow in the dark sand may be a luminescent filler. In another embodiment, the particles may comprise glow in the dark sand alone.

If used as a filler, the glow in the dark particles may create a flow of glowing particles in contrast to its non-luminescent backing creating a “yin-yang effect” throughout the column. This “yin-yang” effect is also present when normal colored particles (e.g., sand that is not luminescent) sand which is darker in color is used against an oil dyed a lighter shade (e.g., black sand particles/light green oil). In this embodiment, the effect may be seen when exposed to ultraviolet light (e.g., a black light), or in daylight/artificial light environments.

Large glow in the dark particles are often referred to as sand. In one embodiment, these particles may be used to produce varying effects when the novelty device is in use. In one embodiment of the innovation, the large glow in the dark particles may be used to invoke a “starry sky” or “black hole effect” when viewed in darkness. In one embodiment, these particles glow brighter than the main sand when suspended in the oil, creating a different effect as they flow over the surface and through the mixture. These particles can also be altered by crushing them further into a smaller particle size. This allows them to be more easily distributed throughout the oil, as they are lighter and can be carried more easily.

In one embodiment, larger particles, especially those having increased hardness, can aid in removing residual material affixed to an inner wall of the vessel. This is achieved through a rapid spinning motion in which centrifugal force presses granules against the walls and the particles act as a scouring pad, effectively cleaning the residue. These larger particles may also be used to create a “falling star” effect, as they fall more rapidly and visibly when coated by the oil than their smaller/lighter counterparts.

In one embodiment, the contents of the vessel (e.g., a novelty lamp) may vary. Various portions of the composition inside the novelty lamp independently may be imparted with color via any suitable coloring agent. In one embodiment a coloring agent can be used to color either or both the water and the oil. The particles may also be colored. For example, the sand may be most any color (e.g., green, blue, pink, etc.), including neon and glow in the dark pigments/colors. Most any coloring agent may be used. In one embodiment, the coloring agent is non-toxic.

In one embodiment, the residual color pigment from the particles aids in coloring its counterpart the oil. In embodiments in which the coloring pigment glows in the dark (e.g., glow in the dark play sand), it works to allow the oil to produce its own independent glow. Similarly, non-luminescent (e.g., non-glowing play sand) may impart residual pigment that may help dye the oil its own color.

In one embodiment, a dye/pigment may be added to impart color to the oil layer. While residual amounts may remain in the particles (e.g., sand) after separation is complete the whole of these substances are absorbed and held in the oil layer. Occasionally, very fine particles of pigment (especially glow pigments) or glitter may be released into the water layer as the oil moves. These, however, at some point will be recaptured by the oil and play very little to no part in coloring the water or particle elements. Oil based powdered pigments may prove to be more effective at coloring oil, this may include any color, style, or function such as glow in the dark, thermochromic, photochromic, glitter, UV reactive, neon, etc.

In one embodiment, the color pigment may be an ultra violet (black light) reactive fine powder pigment. The UV reactive powder is available in a variety of colors. In one embodiment, the color pigment may be UV reactive liquid pigment. UV reactive quality is not necessary for the function of the material. Meaning if desired a flat base color can be substituted.

In one embodiment, glow in the dark powdered pigment similar to UV powdered pigment may be used. The glow in the dark powdered pigment may produce its own charged glow. These smaller particles have the ability to ride the surface of the oil and separate themselves in small “eruptions” off of the surface of the oil at points of contact. Note that these particles make the oil glow very brightly and would probably not be used when certain effects, such as the “Black hole” effect, is desired, as a dark backdrop is required.

In one embodiment, the oil layer contains no pigments or dyes. The particles may also be free of pigments or dyes. If neither the oil layer nor the particles are colored, the contents of the novelty lamp may create a desired “beach” effect or can be used in conjunction with glow particles. The glow particles may become suspended in the translucent medium, displaying a “cloud nebula” effect. The color pigment may be encapsulated or non-encapsulated (waterproof) pigment granules. With the luminescent powder it can have an effect on the duration of glow when the pigment is introduced to water. This can also have an effect on how the oil retains the pigment itself.

In other embodiments, glitter and/or specialty pigments may be used to decorate the contents of the novelty lamp. In one example embodiment, glitter, such children's play glitter, as well as more advanced examples such as “holographic” or “Chameleon” clear coat paint pigment powder may be used. These materials can create a sparkling effect throughout the material. The more advanced paint pigments can also produce a prismatic effect or a color shifting surface such as found on a holographic baseball card. In another example, thermochromic pigment powders can also be utilized, these pigments possess the ability to change its color when exposed to different temperatures such as is achieved with a “mood ring”. In another example, photochromic pigments may be used. These pigments change their color when exposed to UV light such as the sun or a black light. In one embodiment, these pigments can be used on the base and/or cap of the vessel to provide further interactive components to the novelty device. Another possible feature would be to have a laser or light pen capable of drawing designs on the enclosed material itself.

The particles may further include other objects that can be affixed permanently to the vessel or float freely. While these additional features are described as particles, it is to be understood that this description includes elements that are distinct and includes decorative objects. One example is a glass mushroom adhered to the inner base of the vessel, or a floating glass eyeball.

The buoyancy and mass of these objects will determine their actions. If an object is sufficiently buoyant, it will remain in the water separate from the oil and float to the top. Whereas a heavier object will sink and be enveloped by the oil. If the object is in the oil layer, it will be pulled up and dripped down in the same fashion as the particles (e.g., the sand). In one embodiment, the objects may be neutrally buoyant.

According to an aspect of the innovation material from the composition inside the novelty lamp will rise up/drip down/coat affixed inner objects when in use. In one embodiment, the effects created by the compositions inside the novelty lamp may be achieved by rotating/spinning the novelty lamp. The rotation/spinning may create a rising column of at least a portion of the composition. It is appreciated that while the innovation is described as a novelty lamp, these same features (e.g., the composition inside a vessel) could be used in displays not requiring a spinning column i.e., a key chain, a freeway billboard, a waiting room fixture, a fish tank, etc. In one embodiment, the vessel may be encased in a protective matrix (e.g., Lucite or acrylic) that services as a display unit. The display unit may further include lights or mechanical or electrical mixing means. See, for example, FIG. 8.

The novelty lamp may further include a magnetically controlled object such as hoops or cleaner, to act as entertainment and/or for maintenance of the vessel. This would be similar to a magnetic fish tank cleaning brush.

The vessel may include etched or engraved imperfections in the glass. Material can be made to follow imperfections in the glass walls effectively. In one embodiment, the design of the etching/engraving may be customizable. In one embodiment, at least a portion of the composition inside the novelty lamp could be configured to follow a design pattern that is etched, engraved, or otherwise formed in the vessel.

According to an aspect of the innovation, the composition is enclosed in a vessel to form the novelty lamp (or other item). The composition may be housed in most any suitable container according to an aspect of the innovation. Suitable containers/vessels include containers made from glass, ceramic, plastic, or other sturdy materials.

In one embodiment, the vessel is a glass bottle. In a specific example according to the innovation, the vessel is a 1000 ml Boston Round bottle, such as the 1000 ml Boston Round Type III Soda Lime glass bottle.

To create the desired effects described herein, the vessel should be of a suitable shape to achieve an unimpeded circular rotation of the mixed material composition by centrifugal force to create a “growing column” effect. See e.g., FIG. 7. This can be overcome in vessels having non round shapes such as a ten gallon aquarium. As long as a means for sufficiently mixing the elements is present and functioning, a variety of methods could be used to create countless effects with this mixed composition. Methods of mixing the different elements of the composition (i.e., the sand, oil, and water) include air/water pumps and impellers (multiple independent devices could be used, such as several impellers placed on the base of tank or on the surface to form multiple vortexes or columns.) This is only one specific example of the many options. Round or ball shaped vessels may be incapable of mixing elements due to the contents sliding apart from each other and not flipping, this can be remedied through mechanical mixing.

In one embodiment, the vessel may be a polycarbonate safety glass vessels. The vessel may include a coating (e.g., LiquiGluide brand hydrophobic coating) of the inner surface vessel

In one embodiment, the vessel may be enclosed within safety material (e.g., a case or bladder) to protect the vessel. In one embodiment, the safety material may be a removable protective sleeve. In another embodiment, the vessel may be a multi-layer protective cover, e.g., a “bulletproof” container. The vessel may also be coated in a clear, hard acrylic coating, or any hardened coating meant for protection.

In one embodiment, the inner surface of the vessel may become coated by residual mixture which, in some instances, may partially obscure the view of the interior of the vessel. While the exact cause as to why this sometimes occurs is still an unknown, options for removing the residual mixture include the harder material particles described above, magnetic cleaning devices, and an inner permanent coating such as DuPont and 3M'S baked on nonstick Teflon, such as is used in glass kitchen wear, to prevent sticking of the composition material(s).

The vessel may include a lid closure. In one embodiment, the vessel may include a cap. In one embodiment, the closure may be a permanent crimp top such as the closure(s) on some lava lamps or multi dose injection vial of medicine (without the needle membrane). In one embodiment, the closure may be affixed to the primary inner glass vessel to prevent tampering with the contents.

In one embodiment, a tamper resistant cap may be placed over the ends of vessel or vessel sleeve. This will function as a “childproof” deterrent to opening the vessel or outer sleeve and prevent access to the contents of the vessel. In one embodiment, the closure may be removable to allow adults to use the device in its unprotected traditional form if desired. The cap may also serve as a housing for electronics, lighting, or grips as discussed below.

The vessel may be at least partially enclosed in an outer protective sleeve/housing. In one embodiment, the protective sleeve/housing may comprise a fitted polycarbonate sleeve capped at both ends to encase and protect the fragile glass vessel. The protective sleeve/housing may be a safety device to prevent breakage or contamination of mixture if breakage occurs of the inner vessel and may also function in other capacities.

In one embodiment, the end cap(s) of the protective sleeve/housing may be fitted with an ergonomic grip or handle. One such example is depicted in FIG. 8 and may incorporate “bowling ball” type finger holes 222 to allow a safe grip on the device, especially when spinning to create a rising column. Any combination of rubberized or textured surface could also be used to assure a controlled firm grip.

The caps 201 may serve as a housing for visual effects. LEDs 221 may be used to created effects. LEDs 221 may be white, colored, blacklight or UV LEDs. These may be controlled by an electronic circuit 223 to enable flashing, dimming, strobe, or any other combination of lighting sequences. These could be controlled by an on/off switch 224 located within the cap 222 (e.g., within the “bowling ball” grip finger holes), and could be located anywhere inside or outside the caps. Each cap would run on its own independent, rechargeable, internal battery. In one embodiment, these could be controlled by an on/off switch located within the “bowling ball” grip finger holes. They would be charged by electrode nodes coming in contact with the base unit, it having a low voltage charger powered by a wall outlet. This configuration would allow for independent lighting/charging of the material within the vessel, providing one the ability to move around freely without compromising the lighting effect provided by the base unit.

In some embodiments, the vessel may include a base unit. The base unit may be permanently attached (e.g., integrally formed with the vessel or permanently attached thereto) or it may be detachable from the vessel. The base unit may be designed in any size shape or form to safely support and display the vessel and may comprise most any suitable material including, but not limited to, metals, plastics, wood, or a combination thereof.

The base unit may incorporate a low voltage charging controller whose purpose is to charge the lighted end caps of a removable vessel. In one embodiment, the vessel may include a vessel port having point of contact electrodes. This will also serve as the source of power for the base unit effects and functions.

The base unit may have a variety of lighting and/or visual/audio effect, i.e., LEDS, mist, UV, sound effects, speakers, etc. These may be controlled through a physical switch, RF/IR remote, dimmer switch, timer, or any other means of manipulation.

In one embodiment, the base unit can also be permanently affixed to the vessel and may house mechanical means of mixing/combining elements of the vessel

The base may include suction cups or other similar adhesive devices to secure its position.

The contents of the vessel can be mixed/combined to achieve a variety of visual displays. Mixing can be achieved manually or via mechanical/electrical means. Suitable mechanical/electrical means include air pumps, liquid pumps, impellers, conveyor systems, reservoirs, or physical mechanics made to flip/move/spin/mix/manipulate the contents, etc.

While these methods can be designed in a number of ways, the main purpose is to mix the solid contents (sand, particles) with liquid contents (e.g., the oil). Also to rotate/spin this mixture sufficiently as to create a column (if so desired). However in certain instances this may not be required or necessary (i.e. static logo displays, “falling star”) or any other non-rounded static display.

One such example would be a small water pump designed to recirculate the released oil from the top of the vessel by tube back down to the bottom. Here it would be released into a reservoir under the sand base. A small opening in the sand base may act as a filter sufficiently large enough to allow the oil to seep up/rise and permeate the sand, but small enough to prevent particles of sand from falling through. This sand now trapped by the rising oil is forced to repeat its functions indefinitely.

An impeller or impellers or some other form of agitation placed in the caps or on the base of a display could create vortexes of spinning mixture.

When using a conveyer system, a concave “bucket” or other suitable container capable of carrying sand, would physically carry sand to the oil layer at the top where it would be “dumped” recombining the two elements.

In one embodiment, an air compressor may be used to mix/combine the contents of the vessel. For example, a small compressor, such as used in a fish tank air pump, could be used to blow sand particles up into the oil or the oil down into the sand. This can also be used to shoot large glow particles through oil to create a “falling star” effect.

Other mechanical means may be employed that are capable of inverting a vessel end over end rapidly. In one embodiment, the mechanical means may also produce a wobbled spin for a rising column effect. In embodiment having square or rectangular vessels, such as billboards only a simple flip function may be necessary due to the absence of a need to create the column effect. However, impellers or other means could be deployed to supplement for this as well.

According to an aspect of the innovation, disclosed herein is a method of making a vessel (e.g., a novelty lamp). It is to be appreciated that the disclosed amounts of ingredients are guidelines only and that any amount of ingredients may be used depending on the effect desired and the size of the container (e.g., bottle) used to create the vessel.

In one embodiment, the method includes filling a relatively clean, imperfection free container (e.g., a glass or plastic bottle) having a closure, leaving just enough space for the sand, oil, pigment, glow rock, etc. to mix with the chosen form of water.

In one embodiment, the container is a glass 1000 ml Boston Round bottle.

In one embodiment, the vessel (a 1000 ml Boston Round bottle) contents may include oil in a range of about 150 grams to about 350 grams, water in a range of about 350 grams to about 600 grams, and sand in a range of about 100 grams to about 250 grams. It will be appreciated that the contents of the vessel may be increased or decreased proportionally to accommodate smaller or larger vessels or to incorporate additional components such as decorative ingredients. Here as elsewhere in the specification and claims, ranges and values can be combined to form new and non-disclosed ranges.

In one embodiment, the contents include oil in a range of about 300 grams to about 200 grams or about 275 to about 225 grams. In one embodiment, the oil is present in an amount of about 350 grams, about 300 grams, about 275 grams, about 250 grams, about 225 grams, about 215 grams, about 210 grams, about 205 grams, about 200 grams, about 195 grams, about 185 grams, about 175 grams, or about 150 grams.

In one embodiment, the contents include water in a range of about 400 grams to about 550 grams, or about 450 grams to about 500 grams. In one embodiment, the water is present in an amount of about 600 grams, about 575 grams, about 550 grams, about 525 grams, about 500 grams, about 490 grams, about 480 grams, about 470 grams, about 460 grams, about 450 grams, about 440 grams, about 430 grams, about 420 grams, about 410 grams, about 400 grams, about 375 grams, or about 350 grams.

In one embodiment, the contents include sand in a range of about 225 grams to about 150 grams, or about 200 grams to about 100 grams. In one embodiment, the sand is present in an amount of about 250 grams, about 225 grams, about 200 grams, about 190 grams, about 180 grams, about 170 grams, about 160 grams, about 150 grams, about 140 grams, about 130 grams, about 120 grams, about 110 grams, or about 100 grams.

In one embodiment, the vessel is a 1000 ml Boston Round bottle and the contents include about 250 grams of oil, about 480 grams of water, and about 160 grams of sand.

### EXAMPLES

Below are examples of vessels that may be used to create a novelty lamp according to the innovation. Each example used a 100 ml Boston Round bottle. Starting with a clean glass or plastic concave container (bowl or dish) one half cup (approximately 215-250 grams) of sand was measured and poured into the clean glass or plastic concave container (bowl or dish) capable of holding both one cup of oil as well as the sand. Using some type of clean manual stirring apparatus (spoon, stick) the two elements were mixed until thoroughly combined. Other decorative materials could be added to mix at this time. Once the sand and oil have been combined in the dish, a funnel or similar device was placed in the opening of vessel to aid in introducing the mix to the water.

In one embodiment using 1000 ml Boston Round bottle, the components included about 250 g oil, about 477 g water, and about 160 g sand. Other ingredients can be added in almost any amount to accommodate design needs. The amount of each component may be decreased proportionally to accommodate any additional materials.

The spout of the nozzle opening of the funnel was aimed down and directly at the center of the water. This is a precautionary measure to avoid the sand oil mix from coming in contact with the dry sides of the bottle in advance of the water. This may prevent residual material from permanently adhering to the inner walls of the vessel. Use of a nonstick coating (e.g., LiquiGlide or Teflon coatings) may also prevent residual material adherence.

Once the funneling device was positioned and secured properly, the sand/oil mixture was prepared for introduction by rapidly mixing the sand and oil continuously until the two elements combined and flowed freely. This step allowed the material to keep from separating during the introduction process as it may divide itself causing clogs in the funneling device if left stagnant. While rapidly mixing sand and oil the combined contents were slowly poured from the dish into the funneling device at a steady uniform pace. The material should enter the water and begin to separate (this is expected and does not affect outcome).

When calculating the ratio of sand/oil/water to fill the vessel completely, a small void should be included in that formula. This is to allow for the introduction of pigment, dyes, glow rocks, glitter, etc., or any other decorative ingredients without forcing an overflow of contents.

Decorative ingredients including glow rocks were introduced as follows. It is noted that various decorative ingredients may be added, such as pigment powders, glow rocks, glitter, solid objects, dyes, etc. After allowing for a small void equal in volume to the ingredients being added, using a funneling device the ingredients were poured directly into the top layer of oil. The top surface of the vessel contents stopped just short of contact with the closure, leaving a small void of air space. The amount of or lack of air remaining in vessel does play a role in the end result. Too many bubbles can cause the contents to “inflate” swelling in size and degrading or stopping functions. While no air space can also prevent proper agitation. No mixing was necessary as the natural motion of the contents when used is sufficient. It should be said this technique has proven successful for all of the aforementioned materials, other means of mechanically or chemically binding other ingredients may be possible or necessary in the future.

When the device/vessel is in its stagnant resting (non-mixed) state, the device will become separated into its three main elements (e.g., sand, water, and oil). These include the sand layer (bottom), water layer (middle), and the oil layer (top). The other decorative elements such as the glow rocks will come to rest in the bottom sand layer, while the pigments, dyes, glitter, etc. will remain in the top oil layer. The water rests in between the two independently.

In one example, these three elements were recombined by holding the vessel firmly and in a controlled deliberate fashion flipping it end over end. This forced the solid sand bottom layer to fall down through the water as the oil layer begins to rise simultaneously. The resulting momentary contact between the two elements in passing cause the oil to adhere, coat, and absorb the sand along with the other decorative elements. The degree to which these elements combine relies totally on physical contact between the ingredients. Meaning fewer flips of the vessel will result in less “active” material, while a greater number of flips allows for total combination of the elements. The exact number of flips necessary to perform different functions and effects are approximate and can vary from one up to ten or more, this is also dependent on the experience and preference of the user. It has been shown that any amount greater than ten serves little purpose other than to move already combined elements around as a whole within vessel (no further mixing occurs). It is noted that violently shaking the vessel may introduce air bubbles into the mixture, these can have a detrimental effect on the contents inflating them up to and including filling the whole vessel. Also possible is a “static column” in which a column forms but fails to transfer elements effectively. These effects are not desirable and can damage the device permanently.

In this example, immediately after combining, the two elements adhered to each other for a short time. The result of this temporary bond was that the sand being heavier than the oil falls back to the bottom pulling the attached oil along with it. Once this sand/oil mix collected on the bottom it merged with the separate oil covered grains to form a central/main globule. As used herein, the term “globule” is used to describe the sand/oil mixture suspended in the water layer. This term is used to describe configuration of the sand/oil mixture. For example, the globule may have any shape, including, but not limited to spherical or columnar. Some oil coated sand particles or other additives remained neutrally buoyant and “float” or “orbit” independent from the main globule throughout the water layer. These particles can be called “balloons”, “orbs” or “planets” the difference being their shape and actions. Whereas the “balloons” are irregularly shaped with a large oil bubble on top and a small particle of additive hanging from the bottom creating a form similar to a hot air balloon. These “balloons” often end up producing a “falling star” when the additive finally separates. While the smaller more stable “orbs” are more proportionate in their ratio of oil to sand, causing them to remain suspended for a longer duration in the water layer. These orbs normally, after an extended period of floating, are pulled by gravity to the bottom, where they are absorbed by the main globule. “Planets” occur when an “orb” orbits or rotates around any type of column or object.

A very short time after the elements were combined they began to slowly separate themselves. This is due to the temporary bond between the ingredients as the buoyancy of the oil pulls it back towards the surface of the container away from the heavier sand forcing it to “drip” upwards. The oil returning to the surface carries with it residual sand and additive particles. When this large globule is left to release its contents upward without further manipulation, i.e., via a spinning circular motion, it will maximize the duration of total movement. When witnessed in the daylight or UV light this effect is known as the “slow drip” effect. This effect could be useful as a sleep aid for infants, as it allows for the longest period of active movement. An added feature useful in this scenario is that the glow in the dark elements slowly lose their luminescence as the movement of the mixture slows and comes to a halt simultaneously. This creates a dimming/slowing multi effect known as “sleep mode”.

In another embodiment, as the released oil drips to the surface carrying residual particles it soon combines at the top to form an opposing globule at the surface of the vessel. As more and more of these “drips” rise and merge so do the particles carried with them. Once a sufficient amount of these particles collect within the globule they gravitate towards the lowest point pulling the oil with them forming an opposing downward “drip”. This will serve as a release point for the now collectively heavier small spheres of oil and sand/additives which are pulled downwards to be reabsorbed by the bottom globule. The formation seen when both opposing drips are active is labeled as the “hourglass effect.

In another example, immediately after combining elements as described above, a wobbled spin of 1-6 rotations (depending on user strength and experience) followed by a sudden stop may cause a different effect. The centrifugal force and water currents produced by the spinning action continue to rotate inside the vessel after it is ceased. These forces cause the sand/oil mix to spin itself, eventually forcing the materials upward in which can be described as an inverted cone. The materials (depending on sufficient force being delivered) quickly begin to grow from the upper tip of this cone creating the “growing column” effect. Once this column reaches the top of the vessel it begins to deposit mixed materials into an upper globule as in the hourglass effect. Due to this column's solid nature the transfer of material, e.g., sand/glow rocks is much more efficient than the hourglass drips. It should also be noted that this same spinning action can produce single or multiple large suspended globules of mixture including (double columns, irregularly shaped globules of any type or kind being free floating or attached to main globules, and irregularly sized globules) as well. This effect or effects can be described as “liquid statues.”

In another example, the combined elements may create a connected column, yin-yang effect. In the event the centrifugal force is great enough to maintain the “growing column” long enough to deposit a sufficient globule on the top of the vessel, this column may become absorbed at that end connecting the top and bottom globules with a connected column for a short period. This column is capable of transferring the solid materials from the bottom to the top and vice versa. If a light colored oil is used with a darker shade sand or additive it will also produce a “yin-yang” effect within the column itself. This can be described as particles flowing in opposing directions past each other through the connected column, sometimes wrapping around one another in a display similar to a “yin-yang” symbol. This effect is also seen when glow in the dark rocks or pigment is present, only that the glowing particles are backed by non-luminescent oil and sand as opposed to a darker shade. This function can be used at any point in the vessel's period of movement other than complete element separation. The shape of the vessel is important when forming columns through centrifugal force. A circular rounded vessel free from obstruction is the most effective for generating the motion of the currents that produce this effect.

In another example, the combined element mixture may for a (side view/horizontal, “lily pad”/“implosion”/“mushroom cloud” effects. Immediately after combining elements as described above, the vessel was placed on its side horizontally.

In this example, the sand/oil mix falls to the bottom/side of the vessel and begins to separate. This action can cause varying effects as the globules have more surface area to both expel and absorb material. This can result in a wider/shorter column, multiple columns, multiple hourglass drips in any combination or type, the depositing of material independent of main lower globule directly onto the bare sand, a “mushroom cloud” shaped column, balloons, orbs, planets, or any other type of effect etc.

This feature could be exploited in various shape containers as well due to the fact there exists no need for a “rotating column” nor circular current to create such a column. In a basic minimal handheld form, the mixing action could be achieved by turning the square, rectangular, octagonal, or any other size/shape vessel, such as picture frames, billboards, window displays, etc., so long as the separated sand and oil come in sufficient contact with each other in the process. For a larger scale version such as a podium or coffee table, or even up to billboard size displays, mechanical means such as pumps, compressed air, conveyors, etc. would be used for mixing. These could be made to be hidden by exploiting the substances ability to “grow” up an object. For example, the substance climbs up the oil recirculation tube to mask it as an ordinary column. It is to be appreciated that the vessel according to the innovation could be used in any scale. It would also be possible to place impellers or any other means of mixing throughout the top and/or on the bottom of these wider vessels. If impellers were used it should be noted that they should be of a very low “RPM” variety, this being crucial to prevent overmixing. This would create the ability to create multiple columns throughout the interior in a “3D” landscape on demand. These could even be made into the form of a game or to otherwise interact with other material effects in the same vessel. The elements would require constant mixing in this configuration as the impellers would become bogged in the settled sand. However if the “under gravel oil/sand filter recirculation pump system” described earlier, or some other means of mixing were used this could be very successful.

Other effects that can be created using the vessel according to the innovation include the “lily pad” effect when seen from the top or bottom of a clear vessel. When from the top (created by oil bubbles rising and being trapped by the glass). Or the “implosion view” when viewing temporarily affixed sand fall from its position through what was just prior the bottom view.

In another example, the contents can be used to react to UV/black lights. The process for dying the oil includes impregnating it with either powdered, liquid, solid, UV reactive (e.g., DAYGLO, NEON) dyes, materials and pigment. This has so far been accomplished simply by adding the materials by hand in the manufacturing process. The oil will then take on the chosen additives property and remains suspended there exclusively separated from the oil or sand.

Sand can also be made to behave in the same manner simply by choosing a UV reactive DAYGLO OR NEON colored version.

The glow in the dark sand, rocks, pigment, etc. are also charged when exposed to UV/Black light. This has proven to be the most effective method of achieving this goal.

The sand mix can be made to have a different color than the oil or vice versa, as in one UV reactive and one not. This aids in the creation of the “yin-yang” effect when viewed in this mode, generating a flow of opposing particles some of which are UV reactive and some are not. It also produces two tone “orbs, balloons, and planets”. These having a base or darker particle against a reactive oil balloon or vice versa. In one embodiment neon oil may also attach to glow in the dark particles.

When a UV reactive liquid dye is used to color oil and a darker shade sand base is used, the UV reactive oil rising through the darker colored sand is an effect known as “electric worms”. When a darker colored oil is used against a UV reactive sand this effect is known simply as “worms”.

In another example, the content may glow in the dark and may create “Glow in the dark”, “starry sky”, “black hole”, “glow worm”, “night crawler” effects.

When operating in “Glow in the dark” mode the darkest possible environment is preferred to allow the best view of luminescent materials. UV/black lights along with all other light sources are turned off or blocked, this includes any affixed product base or container lights along with any normal (lamps, TVs, ambient light, etc.). This can be accomplished by dimmer switch, R.F/I.R remote, contact switch on vessel, normal switch, or any other means of manipulation.

Once all or a majority of light is extinguished the self-luminescent materials contained within the mixture, having been previously charged sufficiently by a light source begin to glow on their own within the vessel. The amount of glow in the dark material introduced into the vessel, along with the duration of prior charging directly impact the strength and duration of this glow. Also important is the direct exposure of the UV reactive additives to their charging light source.

Depending on the function or effect chosen, the glowing materials will flow through, coat, become suspended in, ride on the surface of, spin within, fall out of, or otherwise move throughout, or rest on the base and other areas of the material.

The oil if combined with a glowing pigment or dye, it will glow independently from the sand if a non-glowing sand is used. The effect of this glowing oil rising through the sand is known as the “glow worm” effect. Glowing sand used against a darker colored oil is known as a “night crawler” effect.

If a glowing oil is used against a non-glowing sand or vice versa, a glow in the dark “yin-yang” effect will

In one embodiment, glow rocks may be added to create a glowing effect. The bright rocks moving within or resting in the darker background elements create the effect of stars floating in space. If these stars are flowing throughout and over a connected column in the dark while charged this is known as the “Black Hole” effect.

If glowing pigment, dye, or sand are used in conjunction with the larger glowing rocks, the glowing elements resting or moving throughout over and within the material produces the “starry sky effect”. The main difference being the self-illumination of the background elements.

Momentarily recharging contents of the vessel with UV light may extend glow indefinitely. This could be done by a regulated timer designed for efficiency. It may also be possible to charge particles with light in a secondary reservoir if mechanical mixing means are used. This would be used to prevent light pollution from degrading the glow in the dark experience.

Some versions of the device such as a “falling star” box may operate exclusively in a glow in the dark mode. A falling star box would be designed to release larger glowing particles through the oil layer to produce quickly falling “stars”.

In one embodiment, various component may adhere to the inner walls of the vessel to create a variety of effects. These can be controlled in their path by means of custom etchings or imperfections in the glass, as the material tends to favor rough surfaces in its natural movement. These effects can sometimes occur naturally and randomly on the inner surface of a vessel. This is remedied by the various nonstick coatings and cleaning devices mentioned earlier. As an overabundance of this effect can obscure overall view of the other functions and may not be desirable. However, if used in a controlled fashion using etched designs in conjunction with nonstick coatings, the material can be made to create a solid backdrop, canopy, or curtain, or any other type effect.

When the oil/sand mix forms a coating on the inner surface of the rounded top and or bottom completely leaving this coated section to overhang the other functions, it is described as the “canopy” effect.

When the sand/oil mix coats a large enough section of the vessel as to provide a backdrop to the other functions this is known as a “curtain”.

It should be noted at any edge of these curtains or canopies the production of small orbs of oil/sand/additive mix can be and are produced. These can break free and fall rapidly or float through the water layer to be later reabsorbed. If glow rocks are present this can also produce a “falling star” effect. When normal or UV reactive elements are used this effect is known as a “drip”.

The action of the materials and elements being exchanged or moving through any elements or additives while adhered to the inner walls is known as the “crawling” effect.

In another example, effects include “orbs”, “planets”, “balloons”, “dissolving”, and “birds nest” effects.

When combined, the elements of the vessel will sometimes produce small independent floating globules of sand/oil/additive mix. These can be two toned depending on the choice pigments/dyes/sand used.

An oblong orb with a heavier particle pulling down on its base is known as a balloon.

The act of an “orb” rotating around the main column or any other function/object is known as “orbiting”.

These independent globules can float neutrally buoyant, fall freely, drip, bounce, collide, dissolve, release particles, or produce any other type of effect.

When these balls or globules are released in quick succession as from the “hourglass” drip, they can collect in a concave indentation in the main top or bottom globules. The surface tension allows these balls to bounce, roll, slide, drop, into this position, where they remain momentarily until they are reabsorbed. The action of several of these balls pooling together is known as the “birds nest” effect. A splash of temporary color will be produced at the point of absorption when contrasting colored elements are used. Whenever this occurs within any effect it is known as the “dissolving” effect.

According to an aspect of the innovation, a method of preparing the composition inside the novelty lamp is disclosed. In one embodiment, the method may include prewashing the particles (e.g., the sand) to remove smaller particles and residual pigment. In some embodiments, this is not done as removing the smaller particles may change the performance of the mixture. Smaller particles aid in creating smaller neutrally buoyant “balloons” which float around the vessel. A large number of small particles will create an “octopus arm” effect where a solid column is replaced by multiple smaller dripping points. While less particles produce a more solid mixture and column.

While the invention has been described with reference to various exemplary embodiments, it will be appreciated that modifications may occur to those skilled in the art, and the present application is intended to cover such modifications and inventions as fall within the spirit of the invention.

What is claimed is:

1. A novelty device for creating and enjoying different patterns or rising and descending material comprising:
a cap;
a water-tight vessel; and
a composition within the vessel comprising:
water;
oil; and
particles that do not dissolve in either the water or the oil,
wherein upon mixing of the water, oil and particles, a column of rising and descending material comprising the water, oil, and particles that forms various patterns.

2. The novelty device of claim 1 wherein the water is selected from tap water, distilled water, purified water, sterilized water, or spring water.

3. The novelty device of claim 1, wherein the oil is a vegetable oil selected from canola oil, corn oil, soybean oil, peanut oil, sunflower oil, safflower oil, cottonseed oil, coconut oil, olive oil, palm oil or a combination of two or more thereof.

4. The novelty device of claim 1, wherein the particles comprise sand particles.

5. The novelty device of claim 1, wherein the particles comprise luminescent particles.

6. The novelty device of claim 1, wherein the particles comprise glitter particles.

7. The novelty device of claim 1 further comprising a base.

8. The novelty device of claim 7, wherein either the cap, the base, or both the cap and the base include a light for illuminating the vessel and the composition within the vessel.

9. The novelty device of claim 7, wherein the base includes a mixing device, wherein the mixing device is operatively connected to the vessel such that the mixing device causes the composition within the vessel to be mixed.

10. The novelty device of claim 9, wherein the mixing device is selected from a pump, a compressed air dispenser, a conveyor, an impeller, or a combination of two or more thereof.

11. The novelty device of claim 1, wherein the water, the oil, and/or at least a portion of the particles include a dye.

12. The novelty device of claim 1, wherein the vessel is a glass bottle.

13. The novelty device of claim 1, wherein the glass bottle is coated with a non-stick coating.

14. The novelty device of claim 1, wherein the composition within the vessel is non-toxic.

15. A novelty device for creating and enjoying different patterns or rising and descending material comprising:
a cap;
a water-tight vessel;
a base having a light for illuminating the vessel; and
a composition within the vessel comprising:
water;
oil; and
particles that do not dissolve in either the water or the oil, wherein upon mixing of the water, oil and particles, a column of rising and descending material comprising the water, oil, and particles that forms various pattern.

16. The novelty device of claim 15, wherein the water is selected from tap water, distilled water, purified water, sterilized water, or spring water.

17. The novelty device of claim 15, wherein the oil is a vegetable oil selected from canola oil, corn oil, soybean oil, peanut oil, sunflower oil, safflower oil, cottonseed oil, coconut oil, olive oil, palm oil or a combination of two or more thereof.

18. The novelty device of claim 15, wherein the particles comprise sand particles.

19. The novelty device of claim 15, wherein the particles comprise luminescent particles.

20. The novelty device of claim 15, wherein the particles comprise glitter particles.
